(19) United States
(12) Patent Application Publication
(10) Pub. No.: US 2018/0184873 A1
(43) Pub. Date: Jul. 5, 2018

(54) CLEANING ROBOT

(71) Applicant: LG ELECTRONICS INC., Seoul (KR)

(72) Inventors: Hanshin KIM, Seoul (KR); Kyungman YU, Seoul (KR); Dongseong KIM, Seoul (KR)

(73) Assignee: LG ELECTRONICS INC., Seoul (KR)

(21) Appl. No.: 15/861,404

(22) Filed: Jan. 3, 2018

(30) Foreign Application Priority Data
Jan. 4, 2017 (KR) 10-2017-0001612

(51) Int. Cl. A47L 11/40; B25J 9/16; A47L 9/28; A47L 9/00; A47L 9/04; B25J 9/00

(52) U.S. Cl. CPC A47L 11/4011; B25J 9/1697; A47L 9/2826; A47L 9/009; A47L 2201/06; B25J 9/0003; A47L 11/4044; A47L 11/4013; A47L 2201/04; A47L 9/0411

(57) ABSTRACT

A cleaning robot includes a fixed body having a battery included therein, a cover surrounding the fixed body, and a movement frame provided between the cover and the fixed body to movably support the cover relative to the fixed body. The movement frame is fastened to at least one point of the cover.

### CROSS-REFERENCE TO RELATED APPLICATIONS

This application claims priority under 35 U.S.C. 119 and 365 to Korean Patent Application No. 10-2017-0001612, filed on Jan. 4, 2017 in the Korean Intellectual Property Office, the disclosure of which is incorporated herein by reference.

### FIELD

The present invention relates to a traveling device, and more particularly, to a robot for performing various operations while traveling about a specific place.

### BACKGROUND

Recently, with development of autonomous traveling technology and automatic control technology, functions of a traveling device and, more particularly, a robot have been increased.

Each technology will now be described. Autonomous traveling technology refers to technology for enabling a machine to autonomously move to avoid an obstacle. According to autonomous traveling technology, a robot autonomously recognizes a position thereof through a sensor and moves to avoid an obstacle.

Automatic control technology refers to technology for enabling a machine to feed values measured by examining the state of the machine back to a control device to automatically control operation of the machine. Accordingly, the machine can be controlled without human manipulation and can be automatically controlled to be positioned within a target range, that is, to reach a target point.

With development and combination of the above-described technologies, an intelligent robot can be implemented and a variety of information and services can be provided through the intelligent robot.

The robot is generally applicable to industrial fields, medical fields, space-related fields and ocean-related fields. For example, a robot may perform repeated operation in machining processes such as automobile production. That is, when a person inputs an operation to be performed, industrial robots repeat the received operation.

In addition, technology for mounting a camera in a robot was conventionally implemented. A robot may recognize a position thereof or an obstacle using a camera. In addition, a captured image can be displayed on a display unit.

### SUMMARY

The present embodiment relates to a cleaning robot having a greater volume and weight than a general cleaning robot and capable of automatically performing cleaning while moving about a wide space of an airport, a terminal or a building.

An object of the present embodiment is to provide a cleaning robot capable of preventing external force applied to a cover from being delivered to an inside of the robot while stably supporting the cover forming appearance of the cleaning robot and having a large volume relative to a main body or a fixed body of the robot.

According to an aspect of the present embodiment, a cleaning robot may include a movement frame which is configured to movably support a cover fanning appearance of the cleaning robot relative to a fixed body received in the cover and is fastened to at least one point of the cover. The movement frame may be located outside the fixed body.

The movement frame may include a plurality of frames located outside the fixed body. The plurality of horizontal frames may be located at a front side, lateral sides and an upper rear side of the fixed body. In this case, the height of the frame located at the upper rear side of the fixed body may be greater than that of the other frames, and the movement frame may further include an additional frame connecting the frame located at the upper side of the fixed body to the other frames.

The cleaning robot may include an inner body contacting a plate fixed to the fixed body and supporting the movement frame relative to the fixed body and a movement shaft connecting the inner body and the movement frame. The inner body may horizontally move based on applied external force.

Accordingly, a cleaning robot according to the invention may include a fixed body, a traveling part provided at a lower portion of the fixed body to enable the cleaning robot to move along a floor surface, a suction part provided at the fixed body to suck foreign materials from the floor surface, a movement frame supported by the fixed body, the movement frame being movable horizontally with respect to the fixed body, and a cover surrounding the fixed body, the cover being secured to the movement frame, wherein the movement frame provided between the cover and the fixed body permits limited movement of the cover with respect to the fixed body.

The traveling part may include a plurality of wheels.

The movement frame may include a plurality of frames, and wherein the plurality of frames includes a first frame located above the fixed body, a second frame located at a front side of the fixed body, a third frame located at a first lateral side of the fixed body, and a fourth frame located at a second lateral side of the fixed body. A height of the first frame from the floor surface may be different from heights of each of the second, third and fourth frames from the floor surface. The plurality of frames may further include a fifth frame connecting the first frame to the third frame, and a sixth frame connecting the first frame to the fourth frame. The first, second, third and fourth frames may be spaced apart from the cover by a predetermined distance.

The movement frame may further include at least one fastening frame connected to at least one of the first, second, third and fourth frames, the at least one fastening frame being fastened to the cover at at least one point.

The cleaning robot may include a side brush protruding from a front lower end of the cover.

The cleaning robot may include a plate provided on the fixed body, an inner body contacting an upper surface of the plate, and a movement shaft connecting the movement frame to the inner body, wherein the inner body is horizontally movable with respect to the plate. The inner body may move horizontally according to external force applied to the cover.

The cleaning robot may include a first plate portion provided at a front portion of the fixed body, a first inner body contacting an upper surface of the first plate portion, a first movement shaft connecting the movement frame to the first inner body, a second plate portion provided at a left rear portion of the fixed body, a second inner body contacting an upper surface of the second plate portion, a second movement shaft connecting the movement frame to the second inner body, a third plate portion provided at a right rear portion of the fixed body, a third inner body contacting an upper surface of the third plate portion, and a third movement shaft connecting the movement frame to the third inner body, wherein the first, second and third inner bodies are arranged in a triangular shape.

The cleaning robot may include at least one elasticity setting part provided between the movement frame and the fixed body to support the movement frame relative to the fixed body. The at least one elasticity setting part may include a first elasticity setting part provided at a front side of the fixed body, a second elasticity setting part provided at a left rear portion of the fixed body, and a third elasticity setting part provided at a right rear portion of the fixed body, wherein the first, second and third elasticity setting parts are arranged in a triangular shape.

The movement frame may include a first frame located above the fixed body, a second frame located at a front side of the fixed body, a third frame located at a first lateral side of the fixed body, and a fourth frame located at a second lateral side of the fixed body.

The first elasticity setting part may be connected to the second frame, wherein the second elasticity setting part and the third elasticity setting part are connected to the first frame.

The at least one elasticity setting part may include a plate provided on the fixed body, an inner body contacting an upper surface of the plate, and a movement shaft connecting the movement frame to the inner body, wherein the inner body is horizontally movable with respect to the plate.

Also, a cleaning robot according to the invention may include a fixed body, a traveling part provided at a lower portion of the fixed body to enable the cleaning robot to move along a floor surface, a suction part provided at the fixed body to suck foreign materials from the floor surface, a movement frame supported by the fixed body, the movement frame being movable horizontally with respect to the fixed body, and a cover surrounding the fixed body, the cover being secured to the movement frame, wherein the movement frame provided between the cover and the fixed body permits limited movement of the cover with respect to the fixed body, wherein the movement frame includes a first frame located above the fixed body, a second frame located at a front side of the fixed body, a third frame located at a first lateral side of the fixed body, a fourth frame located at a second lateral side of the fixed body, a fifth frame connecting the first frame to the third frame, a sixth frame connecting the first frame to the fourth frame, and

at least one fastening frame connected to at least one of the first, second, third and fourth frames, wherein a height of the first frame from the floor surface is different from heights of each of the second, third and fourth frames from the floor surface, wherein the first, second, third and fourth frames are spaced apart from the cover by a predetermined distance, and wherein the at least one fastening frame is fastened to the cover at at least one point.

The cleaning robot may include an elasticity setting part provided between the movement frame and the fixed body to support the movement frame relative to the fixed body. The elasticity setting part may include a plate provided on the fixed body an inner body contacting an upper surface of the plate, and a movement shaft connecting the movement frame to the inner body, wherein the inner body is horizontally movable with respect to the plate.

Finally, a cleaning robot according to the invention may include a fixed body, a traveling part provided at a lower portion of the fixed body to enable the cleaning robot to move along a floor surface, a suction part provided at the fixed body to suck foreign materials from the floor surface, a movement frame supported by the fixed body, the movement frame being movable horizontally with respect to the fixed body, the movement frame including a first frame located above the fixed body, a second frame located at a front side of the fixed body, a third frame located at a first lateral side of the fixed body, and a fourth frame located at a second lateral side of the fixed body, a cover surrounding the fixed body, the cover being secured to the movement frame, a plate provided on the fixed body, an inner body contacting an upper surface of the plate, and a movement shaft connecting the movement frame to the inner body, wherein the inner body, the movement shaft and the movement frame are horizontally movable with respect to the plate to permit limited movement of the cover with respect to the fixed body.

### BRIEF DESCRIPTION OF THE DRAWINGS

FIG. 1 is a diagram showing the appearance of a cleaning robot according to an embodiment of the present invention.

FIG. 2 is a perspective view showing a main body provided in a cleaning robot according to an embodiment of the present invention.

FIG. 3 is a diagram showing an example of a fastening structure between a cover and a movement frame of a cleaning robot according to an embodiment of the present invention.

FIG. 4 is a diagram showing a fixed body included in a main body of a cleaning robot according to an embodiment of the present invention.

FIG. 5 is a diagram showing a movement frame provided between a cover and a fixed body of a cleaning robot according to an embodiment of the present invention.

FIG. 6 is a diagram showing an embodiment of fastening points between a cover and a movement frame of a cleaning robot.

FIG. 7 is a perspective view showing components connected to a movement frame to fix the movement frame to a fixed body.

FIG. 8 is a diagram showing a movement frame and a fixed body.

FIG. 9 is a perspective view showing an elasticity setting part provided between a movement frame and a fixed body of a cleaning robot.

### DETAILED DESCRIPTION OF THE PREFERRED EMBODIMENT

A traveling device refers to a device which can move from a specific position to another position using power. The traveling device may be divided into an automatic traveling device and a manual traveling device. The automatic traveling device may refer to a traveling device which autonomously travels along a predetermined path without user manipulation. As an example of the traveling device, there is a movable robot. The movable robot may perform various operations while moving using traveling parts, e.g., wheels or legs.

For convenience of description, in this specification, the present invention will be described using a cleaning robot. The cleaning robot may mean a robot for performing cleaning operation while moving about a specific region. For example, the cleaning robot may include an airport cleaning robot for performing cleaning operation while moving about a wide space such as an airport.

The present invention is not limited to the cleaning robot and is applicable to a traveling device including a cleaning robot.

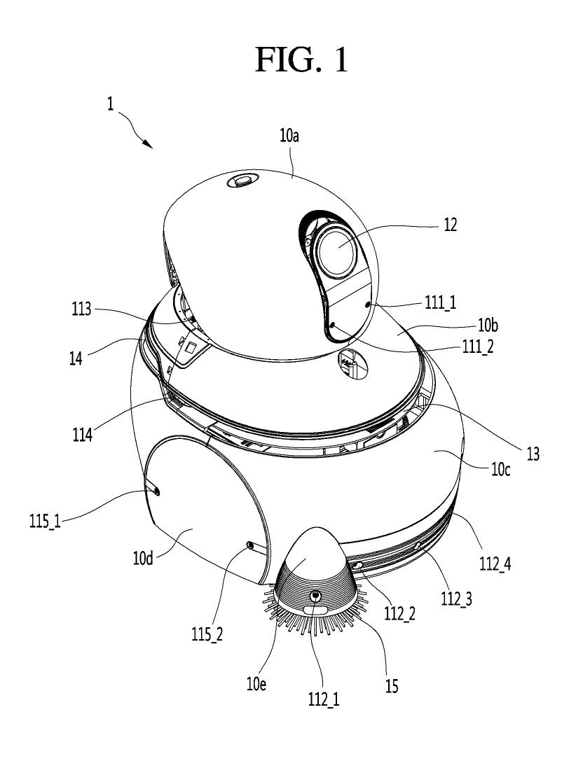

FIG. 1 is a diagram showing the appearance of a cleaning robot according to an embodiment of the present invention.

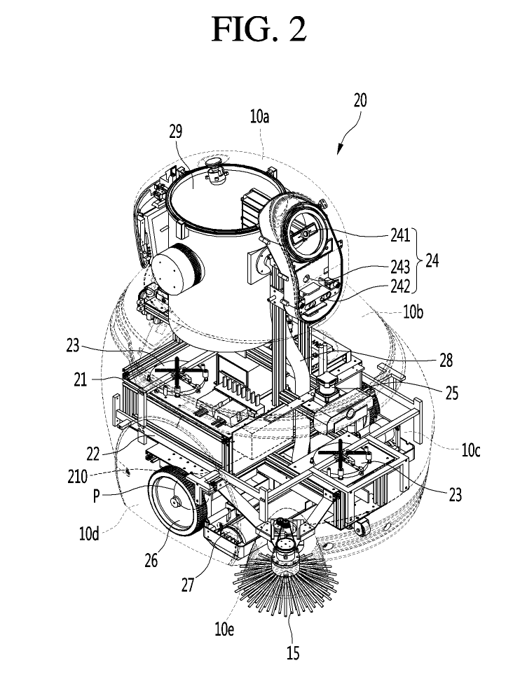

Referring to FIG. 1, the cleaning robot 1 includes covers 10a, 10b, 10c, 10d and 10e (collectively, 10) covering various components provided in a main body 20 (see FIG. 2). The cover 10 surrounds the outside of the main body 20 to form the appearance of the cleaning robot 1.

For example, the cover 10 may include a top cover 10a, a middle cover 10b provided below the top cover 10a and a bottom cover 10c provided below the middle cover 10b. The top cover 10a, the middle cover 10b and the bottom cover 10c may be integrally formed as one cover or may be separately formed as separate covers.

The top cover 10a may be located at the uppermost end of the cleaning robot 1. For example, the top cover 10a may be fox in a dome shape, without being limited thereto. The top cover 10a may include a light transmission unit 12 for enabling at least one camera provided in the main body 20 to capture the periphery (e.g., the front side) of the cleaning robot 1. The light transmission unit 12 may be placed at one side of a front surface of the top cover 10a. The light transmission unit 12 may be made of a material for transmitting light, such as glass, plastic, acryl, etc., without being limited thereto. The at least one camera may collect light reflected from objects located near the cleaning robot 1 and received through the light transmission unit 12, thereby capturing the objects located near the cleaning robot 1. For example, at least one camera may be used to recognize the face of a user or an obstacle located at the front side of the cleaning robot 1 or to sense the current position of the cleaning robot. The top cover 10a may be located at a height where the at least one camera can recognize the user's face or more accurately recognize the current position of the cleaning robot. For example, the top cover 10a may be located at a height (e.g., about 140 cm) less than the height of an adult.

The middle cover 10b may be provided below the top cover 10a. The width of the middle cover 10b may be gradually increased from the upper side to the lower side thereof. For example, if the middle cover 10b has a cylindrical shape, the diameter of the middle cover 10b may be increased from the upper side to the lower side thereof. In some embodiments, the middle cover 10b may be included in the top cover 10a. In this case, the cover 10 may be divided into a top cover (or a first cover) and a bottom cover (or a second cover) with respect to recessed parts 13 and 14.

The bottom cover 10c may be provided below the middle cover 10b. The bottom cover 10c may have a greater width than the top cover 10a and the middle cover 10b.

A battery, traveling parts (e.g., wheels), various boards (e.g., printed circuit boards (PCBs)), etc. may be received in the bottom cover 10c. In some embodiments, the bottom cover 10c may be formed to surround the outsides of the traveling parts 26 (see FIG. 2). In another embodiment, the bottom cover 10c may include traveling-unit covers 10d surrounding the outsides of the traveling parts 26. In another embodiment, if a side brush 15 protruding to a front lower end of the cleaning robot 1 is provided, the bottom cover 10c may be formed to surround the outside of the side brush 15. In some embodiments, the bottom cover 10c may further include a side-brush cover 10e surrounding the outside of the side brush 15.

The cover 10 may include a plurality of sensors 111_1 to 115_2 (collectively referred to as a sensor unit 11) for sensing whether an object is present within a predetermined distance from the cleaning robot 1. The sensor unit 11 may be provided at various positions of the top cover 10a, the middle cover 10b and the bottom cover 10c.

Meanwhile, the cover 10 may include a first recessed part 13 and a second recessed part 14. The first recessed part 13 and the second recessed part 14 may be recessed from the outside of the cover 10 to the inside of the robot. The top cover 10a and the middle cover 10b are positioned above the first recessed part 13 and the second recessed part 14 and the bottom cover 10c may be positioned below the first recessed part 13 and the second recessed part 14.

In particular, the cover 10 according to the embodiment of the present invention may be included in the main body 20 of the cleaning robot 1 and may serve as a bumper for protecting various components connected to the fixed body 21 (see FIG. 2) from external impact. To this end, since the cover 10 is not directly connected to the fixed body 21 of the cleaning robot 1, it is possible to minimize movement of the fixed body 21 and the various components connected to the fixed body 21 when the cover 10 is moved by external impact.

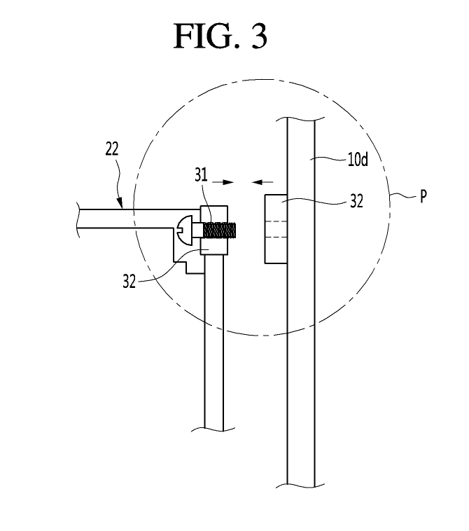

FIG. 2 is a perspective view showing a main body provided in a cleaning robot according to an embodiment of the present invention, and FIG. 3 is a diagram showing an example of a fastening structure between a cover and a movement frame of a cleaning robot according to an embodiment of the present invention.

Referring to FIGS. 2 and 3, the main body 20 of the cleaning robot 1 may include a fixed body 21, a movement frame 22, one or more elasticity setting parts 23 and traveling parts 26. The components shown in FIG. 2 are not essential in implementation of the main body 20 of the cleaning robot 1. Accordingly, the main body 20 of the cleaning robot 1 described in this specification may have more or fewer components than the above-described components.

Specifically, among the above-described components, the fixed body 21 may be connected to various parts necessary for operation of the cleaning robot 1 and the other components. In this specification, the fixed body 21 may include a frame configuring the main body 20. The fixed body 21 may be received in the cover 10. That is, the cover 10 may be formed to surround the outside of the fixed body 21.

The fixed body 21 may include various boards for controlling overall operation of the cleaning robot 1. For example, the fixed body 21 may include some or all of a main board for managing overall driving of the cleaning robot 1, a board for processing data, collected through the sensor unit 11, the camera unit 24 and the lidar sensor 25 and/or a board for controlling operation for supplying power of the battery 210 to the components included in the cleaning robot 1. The battery 210 may be located in the fixed body 21. The battery 210 may provide power necessary for operation of the cleaning robot 1 to various components.

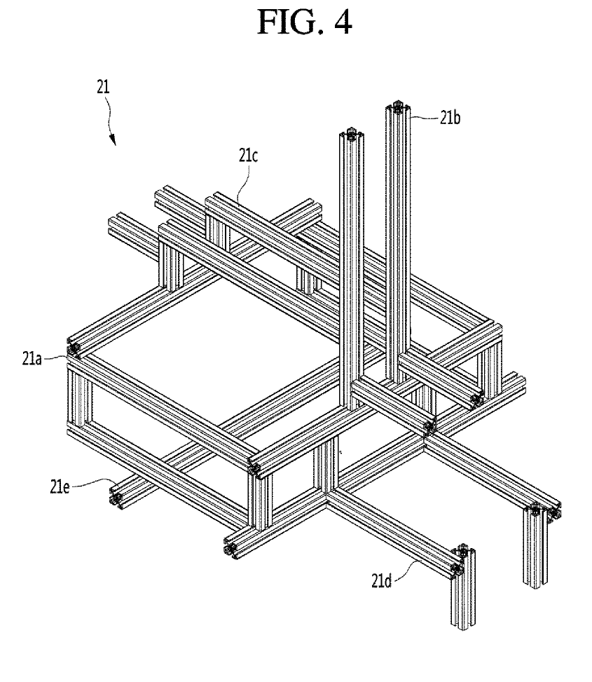

In addition, the fixed body 21 may be connected to various components (e.g., a lidar sensor 25 and the traveling unit 26) necessary for operation of the cleaning robot 1 to fix a location of the various components. The detailed structure of the fixed body 21 will be described below with reference to FIG. 4.

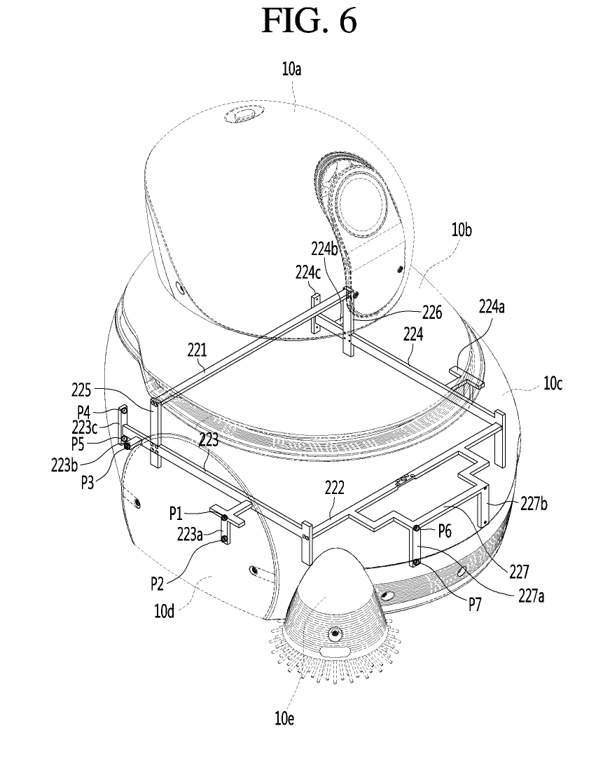

The movement frame 22 is provided between the cover 10 and the fixed body 21 to support the cover 10 movably relative to the fixed body 21. The movement frame 22 may be fastened to at least one point P of the cover 10 to support the cover 10 relative to the fixed body 21 while moving according to movement of the cover 10. For example, as shown in FIG. 3, the cover 10 (e.g., traveling-unit cover 10d) located at a fastening point P and the movement frame 22 may include a fastening boss 32 such that the cover 10 and the movement frame 22 are fastened to each other by a fastening screw 31 and the fastening boss 32. In some embodiments, the cover 10 or the movement frame 22 may include a plurality of fastening bosses such that the cover 10 and the movement frame 22 are fastened to each other at a plurality of points. The method of fastening the cover 10 and the movement frame 22 is not limited to the embodiment shown in FIG. 3 and various fastening methods may be used. An embodiment of the points where the cover 10 and the movement frame 22 are fastened will be described below with reference to FIG. 6.

As described above with reference to FIG. 1, if the cover 10 includes the top cover 10a, the middle cover 10b and the bottom cover 10c (the bottom cover 10c includes the traveling-unit cover 10d), the movement frame 22 may be fastened to the bottom cover 10c and may not be fastened to the top cover 10a and the middle cover 10b. Accordingly, the movement frame 22 may move based on movement of the bottom cover 10c. However, in some embodiments, the movement frame 22 may be fastened to the top cover 10a or the middle cover 10b and, in this case, the movement frame 22 may move based on movement of the top cover 10a or the middle cover 10b.

In addition, the movement frame 22 may be connected to the fixed body 21 through one or more elasticity setting parts 23 and, at the same time, may be supported relative to the fixed body 21. That is, since the movement frame 22 and the cover 10 are connected to the fixed body 21 through the one or more elasticity setting parts 23, the elasticity setting parts 23 may be provided as fasteners between the cover 10 and the fixed body 21.

The one or more elasticity setting parts 23 may minimize delivery of external force to the fixed body 21 using an elastic member (e.g., a spring, etc.) having elastic force, even when the cover 10 and the movement frame 22 are moved by external force. That is, the elastic member may absorb external force applied to the cover 10 as elastic deformation. Accordingly, even when the cover 10 and the movement frame 22 are moved by external force, the fixed body 21 is not moved, thereby preventing various components connected or fixed to the fixed body 21 from being damaged or broken.

In addition, the one or more elastic setting parts 23 may elastically support the movement frame 22 relative to the fixed body 21. That is, after the cover 10 and the movement frame 22 are moved by external force, the elastic setting parts 23 may return and fix the movement frame 22 to and at a reference position using elastic force.

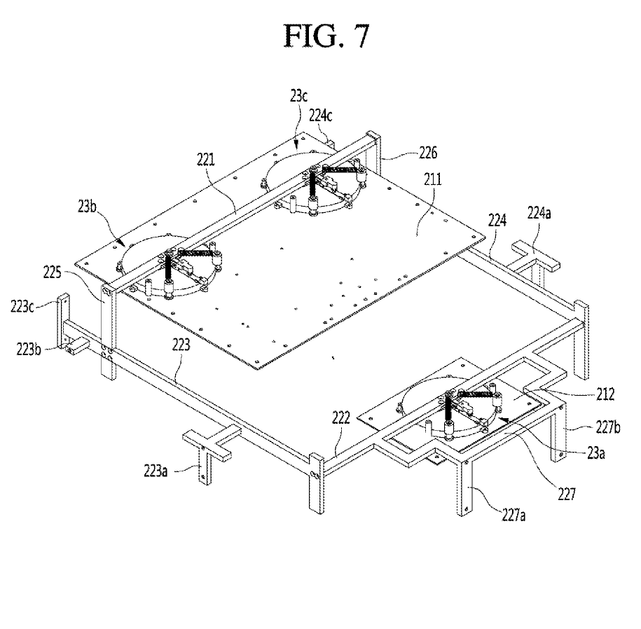

According to the embodiment of FIG. 7 to be described later, the main body 20 may include a first elasticity setting part 23a, a second elasticity setting part 23b, and a third elasticity setting part 23c respectively provided at the front side and lateral rear sides of the fixed body 21. The first to third elasticity setting parts 23a to 23c provided in the fixed body 21 may be arranged in a triangular shape when viewed from the top of the cleaning robot 1. Accordingly, the cover 10 and the movement frame 22 may be stably supported relative to the fixed body 21 by the first to third elasticity setting parts 23a to 23c.

Meanwhile, since the cleaning robot 1 may perform cleaning operation while traveling forward, a probability of collision with an obstacle occurring at the front side of the cleaning robot 1 may be highest. Accordingly, in order more efficiently protect various components of the main body 20 from external force applied to the front side of the cleaning robot 1, as described above, first to third elasticity setting parts 23a to 23c are provided in a triangular shape and, particularly, the internal angle of the vertex corresponding to the first elasticity setting part 23 at the front side of the fixed body 21 may be less than 60°. That is, the distance between the center of the fixed body 21 and the first elasticity setting part 23a may be greater than the distance between the center of the fixed body 21 and the second elasticity setting part 23b, and may be greater than the center of the fixed body 21 and the third elasticity setting part 23c. Therefore, the first to third elasticity setting parts 23a to 23c may stably absorb external force applied to the front side of the cleaning robot. Accordingly, the cover 10 may more efficiently protect the various components of the main body 20 from external force applied to the front side of the cleaning robot 1.

The traveling parts 26 may be provided below the fixed body 21. For example, the traveling parts 26 may be connected to a lower fixed body 21e (referring to FIG. 4). Although wheels 26 are shown as an example of the traveling parts 26 in FIG. 2, the traveling parts 26 may include legs in another embodiment. In addition, although two wheels are provided at both sides of the cleaning robot in this specification, the number of wheels may be variously changed. The wheels 26 rotate based on rotation force applied by a driving unit (not shown), such that the cleaning robot 1 travels. In some embodiments, a caster for aiding traveling of the cleaning robot 1 may be provided at the front or rear side of the cleaning robot 1.

In some embodiments, the cleaning robot 1 may further include a side brush 15 protruding to the front lower end of the cleaning robot, a camera unit 24 for capturing the front side of the cleaning robot, a lidar sensor 25 for sensing an object located in the front direction of the cleaning robot 1, a suction module 27 for sucking in foreign materials on the ground, a cleaning module 29 for collecting the sucked foreign materials and a suction pipe 28 provided between the suction module 27 and the cleaning module 29. For example, the camera unit 24 may include a simultaneous localization and mapping (SLAM) camera 241, a red, green, blue, distance (RGBD) camera 242, and a stereo camera (or stereoscopic camera 243. The suction module 27 may further a driving motor for rotating an agitator and a timing belt. The cleaning module 29 may include a dust collection motor and a dust collector.

Using the various components of the main body 20 described with reference to FIG. 2, the cleaning robot 1 may perform cleaning operation while freely moving about a region of a specific place (e.g., an airport, etc.).

As described above, various components are included in the main body 20 of the cleaning robot 1. The cover 10 (more particularly, the bottom cover 10c) forming the appearance of the cleaning robot 1 may serve as a bumper for protecting the various components included in the main body 20 from external impact (e.g., collision with an obstacle, external force, etc.) occurring at various positions or in various directions. In order for the bottom cover 10c to serve as a bumper, the movement frame 22 may be fastened to at least one point of the bottom cover and connected to at least one point of the fixed body 21.

Hereinafter, the fixed body 21 provided in the main body 20 will be described in greater detail.

FIG. 4 is a perspective view showing a fixed body provided in a main body of a cleaning robot according to an embodiment of the present invention.

Referring to FIG. 4, the fixed body 21 may include a main fixed body 21a, a first upper fixed body 21b and a second upper fixed body 21c provided above the main fixed body 21a, a front fixed body 21d provided at the front side of the main fixed body 21a, and a lower fixed body 21e provided below the main fixed body 21a.

The main fixed body 21a may have a plurality of frames fastened to each other to form a three-dimensional structure having a predetermined volume and may form a basic frame of the main body 20. For example, as shown in FIG. 4, the main fixed body 21a may have a plurality of frames fastened to each other to have a rectangular parallelepiped shape but the shape of the main fixed body 21a is not limited to the rectangular parallelepiped shape. At least one plate may be fastened to the exterior of the main fixed body 21a and a battery 210 or a main board of the main body 20 may be provided in or above the main fixed body 21a.

The first upper fixed body 21b and the second upper fixed body 21c may be provided above the main fixed body 21a. The first upper fixed body 21b may include at least one frame extending in a longitudinal direction, and the second upper fixed body 21c may include at least one frame extending in a lateral direction toward the front and rear sides of the cleaning robot 1. For example, the camera unit 24 may be fixed to the first upper fixed body 21b toward the front side of the cleaning robot 1. In addition, the cleaning module 29 of FIG. 2 may be seated in the second upper fixed body 21c. In some embodiments, the cleaning module 29 may be fastened to the first upper fixed body 21b and the second upper fixed body 21c, thereby being more stably fixed.

The front fixed body 21d may be provided at the front side of the main fixed body 21a. A second plate 212, to which a first elasticity setting part 23a described below with reference to FIG. 7 may be fastened, may be fastened to the front fixed body 21d. In some embodiments, a caster assisting traveling of the traveling parts 26 may be fastened to the lower part of the front fixed body 21d.

The lower fixed body 21e may be provided below the main fixed body 21a. The lower fixed body 21e may include at least one frame extending in a lateral direction toward both lateral sides of the cleaning robot 1. The traveling parts 26 and the suction module 27 may be fastened to the lower fixed body 21e. In some embodiments, the suction module 27 may be fastened to at least one of the main fixed body 21a, the front fixed body 21d, and the lower fixed body 21e.

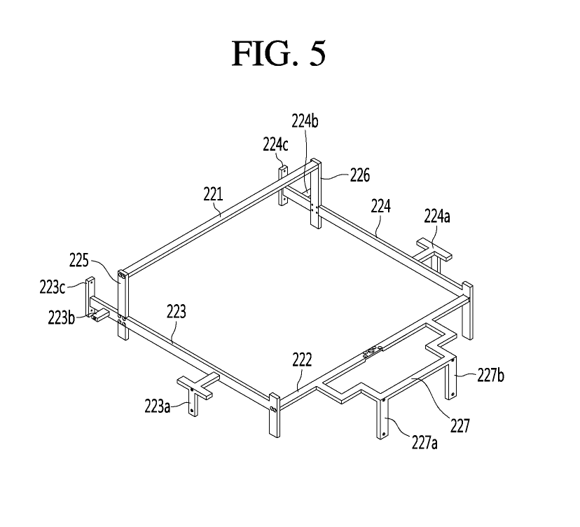

Hereinafter, the movement frame 22 according to the embodiment of the present invention will be described with reference to FIGS. 5 to 9.

FIG. 5 is a diagram showing a movement frame provided between a cover and a fixed body of a cleaning robot according to an embodiment of the present invention, and FIG. 6 is a diagram showing an embodiment of fastening points between a cover and a movement frame of a cleaning robot.

Referring to FIGS. 5 and 6, the movement frame 22 may include a plurality of frames adjacent to the inner circumferential surface of the cover 10 (e.g., the bottom cover 10c) and located at front, rear and both lateral sides of the center of the cleaning robot 1. For example, the movement frame 22 may include a first frame 221 and a second frame 222 extending in a lateral direction toward both lateral sides of the cleaning robot 1 and a third frame 223 and a fourth frame 224 extending in a lateral direction toward the front and rear sides of the cleaning robot 1. For example, the first frame 221 may be located above the main fixed body 21a, and the second frame 222 may be located at the front side of the main fixed body 21a. In addition, the third frame 223 and the fourth frame 224 may be located at both lateral sides of the main fixed body 21a. In this case, although the movement frame 22 has a rectangular shape when viewed from the top, the shape of the movement frame 22 is not limited thereto.

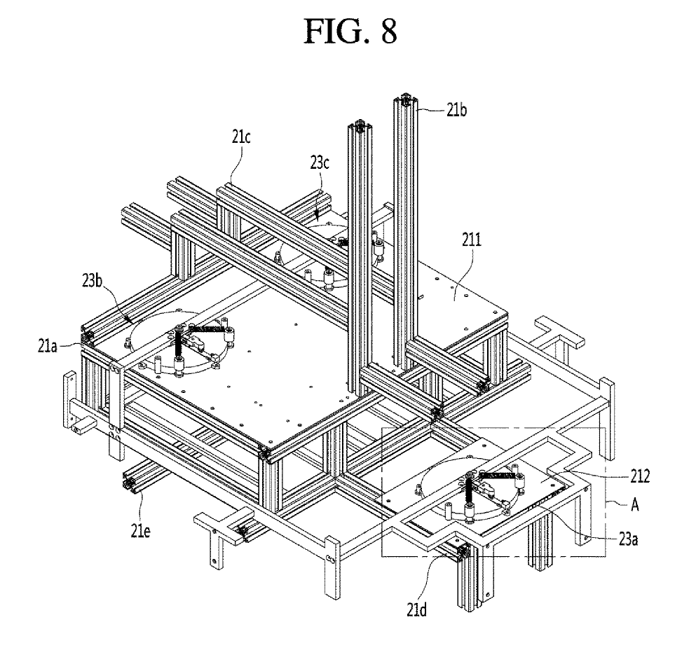

In some embodiments, based on the arrangements of various components received in the bottom cover 10c and the shape of the fixed body 21, the movement frame 22 may be provided outside the fixed body 21 (specifically, the main fixed body 21a) so as not to be directly brought into contact with the above-described components and the fixed body 21. For example, the height of the first frame 221 from the ground may be different from the heights of the second frame 222 to the fourth frame 224 from the ground. As described below with reference to FIG. 8, the first frame 221 may be located above the main fixed body 21a and the second to fourth frames 222 to 224 may be provided at the front and both lateral sides of the main fixed body 21a. Therefore, the height of the first frame 221 from the ground may be greater than the heights of the second to fourth frames 222 to 224 from the ground.

In this case, the movement frame 22 may include a fifth frame 225 for connecting the first frame 221 and the third frame 223 and a sixth frame 226 for connecting the first frame 221 and the fourth frame 224. In this case, the movement frame 22 may have an “L” shape when viewed from one lateral side.

As in the embodiment shown in FIG. 5, when the movement frame 22 includes first to sixth frames 221 to 226, the first frame 221 may be fastened to the fifth frame 225 and the sixth frame 226, and the second frame 222 may be fastened to the third frame 223 and the fourth frame 224. The third frame 223 may be fastened to the second frame 222 and the fifth frame 225, and the fourth frame 224 may be fastened to the second frame 222 and the sixth frame 226.

In some embodiments, the bottom cover 10c may be formed such that the front side thereof protrudes as compared to the rear and both lateral sides thereof, in order to protect the side brush 15 or the suction module 27 provided at the front lower end of the fixed body 21 or to more efficiently protect the internal components upon colliding with a front obstacle. Therefore, the front side of the bottom cover 10c and the second frame 222 may be spaced apart from each other by a predetermined distance or more. In order to efficiently fasten the front side of the bottom cover 10c and the movement frame 22, the movement frame 22 may further include a seventh frame 227 formed at the front side of the second frame 222.

The movement frame 22 may be fastened to at least one fastening point of the bottom cover 10c. However, each of the frames 221 to 226 of the movement frame 22 and the bottom cover 10c are spaced apart from each other by a predetermined distance, such that each of the frames 221 to 226 may not be easily fastened to the bottom cover 10c.

Therefore, the movement frame 22 may further include one or more fastening frames 223a to 223c, 224a to 224c and 227a to 227b connected to any one of the frames 221 to 226, in order to be fastened to the bottom cover 10c.

For example, the first fastening frame 223a and the second fastening frame 223b may be connected to the third frame 223 toward the lateral side (e.g., right side) of the cleaning robot 1. The third fastening frame 223c may be connected to the third frame 223 toward the rear side of the cleaning robot 1. The fourth fastening frame 224a and the fifth fastening frame 224b may be connected to the fourth frame 224 toward the lateral side (e.g., left side) of the cleaning body 1, and the sixth fastening frame 224c may be connected to the fourth frame 224 toward the rear side of the cleaning robot 1. In addition, the seventh fastening frame 227a and the eighth fastening frame 227b may be connected to the seventh frame 227 toward the front side of the cleaning robot 1.

Meanwhile, the fastening frames may be formed at positions symmetrical to each other with respect to a virtual line connecting the front and rear sides of the cleaning robot 1. That is, the first fastening frame 223a and the fourth fastening frame 224a, the second fastening frame 223b and the fifth fastening frame 224b, the third fastening frame 223c and the sixth fastening frame 224c, and the seventh fastening frame 227a and the eighth fastening frame 227b may be formed at positions symmetrical to each other.

The movement frame 22 may be connected to the bottom cover 10c as the plurality of fastening frames 223a to 223c, 224a to 224c and 227a to 227b is fastened to the bottom cover 10c.

Referring to FIG. 6, the bottom cover 10c (including the traveling-part cover 10d of FIG. 1) may be fastened to the movement frame 22 and, more specifically, the plurality of fastening frames 223a to 223c, 224a to 224c and 227a to 227b at a plurality of fastening points P1 to P7 of a plurality of contact surfaces contacting the plurality of fastening frames 223a to 223c, 224a to 224c and 227a to 227b. The examples of the method of fastening the movement frame (fastening frame) and the bottom cover 10c was described with reference to FIG. 3 and thus a description thereof will be omitted.

According to the embodiment shown in FIG. 6, the first fastening frame 223a and the bottom cover 10c may be fastened to each other at the first fastening point P1 and the second fastening point P2 included in the contact surface between the first fastening frame 223a and the bottom cover 10c. Similarly, the second fastening frame 223b and the bottom cover 10c may be fastened to each other at the third fastening point P3, and the third fastening frame 223c and the bottom cover 10c may be fastened to each other at the fourth fastening point P4 and the fifth fastening point P5. The seventh fastening frame 227a and the bottom cover 10c may be fastened to each other at the sixth fastening point P6 and the seventh fasting point P7.

Although not shown, as described above, since the fastening frames are formed at positions symmetrical to each other with respect to a virtual line connecting the front and rear sides of the cleaning robot 1, the fastening points may be located at symmetrical positions.

That is, the movement frame 22 and the bottom cover 10c may be fastened to each other at at least one fastening point, thereby being more stably connected.

In addition, the positions and number of the plurality of fastening points P1 to P7 shown in FIG. 6 are exemplary and are not limited thereto.

FIG. 7 is a perspective view showing components connected to a movement frame to fix the movement frame to the fixed body, and FIG. 8 is a perspective view showing the movement frame and the fixed body.

Referring to FIGS. 7 and 8, the cleaning robot 1 may include one or more elasticity setting parts 23a to 23c connected to the movement frame 22. As shown in FIG. 7, the one or more elasticity setting parts may include a first elasticity setting part 23a connected to the second frame 222 and a second elasticity setting part 23b and a third elasticity setting part 23c connected to the first frame 221.

For example, the elasticity setting parts 23a to 23c may be provided in an acute-angled triangular shape and may be fixed to the fixed body 21 by a first plate 211, to which the second elasticity setting part 23b and the third elasticity setting part 23c are fastened, and a second plate 212, to which the first elasticity setting part 23a is fastened. In some embodiments, the first plate 211 and the second plate 212 may be understood as being included in the fixed body 21. For example, the first plate 211 may be fastened to the main fixed body 21a and the second plate 212 may be fastened to the front fixed body 21d. In this case, the first elasticity setting part 23a may be provided at the front side of the fixed body 21 (specifically, the main fixed body 21a), and the second elasticity setting part 23b and the third elasticity setting part 23c may be provided above the fixed body 21 to form the acute-angled triangle along with the first elasticity setting part 23a. As a result, the movement frame 22 is connected and supported at three points located in the acute-angled triangular shape of the fixed body 21, thereby stably supporting the cover 10 having a large volume and weight relative to the fixed body 21.

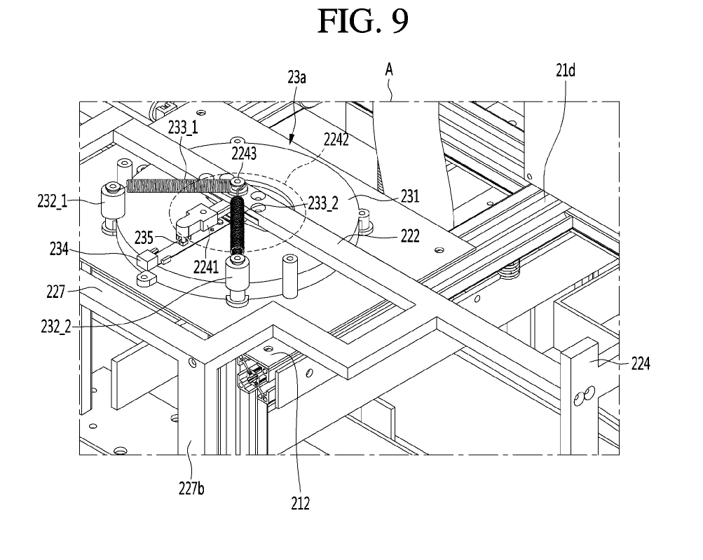

In addition, the one or more elasticity setting parts 23a to 23c may enable the movement frame 22 to freely move relative to the fixed body 21. Therefore, even when the cover 10 and the movement frame 22 move by external force, the fixed body 21 may not move. To this end, the one or more elasticity setting parts 23a to 23c may be connected to the movement frame 22 using an elastic member. This will be described in greater detail below with reference to FIG. 9.

Meanwhile, as shown in FIG. 8, the movement frame 22 may be located outside the fixed body 21 (specifically, the main fixed body 21a) in order to avoid direct contact with the fixed body 21 upon movement. In particular, the movement frame 22 and the fixed body 21 may be spaced apart from each other by greater than a predetermined distance and the predetermined distance may correspond to a maximum movement distance of the movement frame 22 and the cover 10.

FIG. 9 is a perspective view showing an elasticity setting part provided between a movement frame and a fixed body of a cleaning robot.

In FIG. 9, the configuration of the elasticity setting part 23 according to the embodiment of the present invention will be described through the elasticity setting part 23a provided at the front side of the fixed body 21. However, the configuration of each of the elasticity setting parts 23b and 23c provided at the lateral rear side of the fixed body 21 is substantially equal to that of the elasticity setting part 23a provided at the front side of the fixed body.

Referring to FIG. 9, the movement frame 22 (in the embodiment shown in FIG. 9, the second frame 222) may be connected to an inner body 2242 contacting the upper surface of the second plate 212 fastened to the front fixed body 21d to support the movement frame 22 movably relative to the fixed body 21. For example, the inner body 2242 may have a circular plate shape without being limited thereto. The inner body 2242 may be located below the second frame 222. The inner body 2242 may be connected to the second frame 222 through a movement shaft 2243 formed perpendicular to the second frame 222. That is, the movement shaft 2243 may connect the movement frame 22 and the inner body 2243. In this case, when the movement frame 22 moves according to external force applied to the cover 10, the inner body 2242 may also move in a horizontal direction.

The first elasticity setting part 23a may include a holder 231 for enabling horizontal movement of the movement frame 22 and disabling vertical movement of the movement frame 22. The holder 231 may be fastened to the second plate 212 of the fixed body 21. A reception space for receiving the inner body 2242 may be formed in the holder 231, and the inner body 2242 may be received in the reception space. In order for the inner body 2242 to move in the reception space, the size of the reception space may be greater than that of the inner body 2242.

The holder 231 may include a stopper formed at the upper portion of the reception space. The inner body 2242 received in the reception space may be connected to the movement frame 22 through the movement shaft 2243 passing through the stopper. At this time, in order to prevent the inner body 2242 from escaping from the holder 231, the size of the stopper may be less than that of the inner body 2242. In addition, the movement range of the movement frame 22 may be set according to the size of the stopper. As the size of the stopper increases, the movement range of the movement frame 22 may increase and, as the size of the stopper decreases, the movement range of the movement frame 22 may decrease.

In addition, the first elasticity setting part 23a may further include elastic members 233_1 to 233_2 to connect a holder 231 and the second frame 222. One ends of the elastic members 233_1 to 233_2 may be connected to spring connection bodies 232_1 and 232_2 coupled to the holder 231 or the edge of the holder 231, and the other ends thereof may be connected to the second frame 222 or the movement shaft 2243 connected to the second frame 222.

The elastic members 233_1 to 233_2 may be returned to the reference position after the movement frame 22 moves. For example, the elastic members 233_1 to 233_2 may be implemented by tension springs.

As shown in FIG. 9, the first elasticity setting part 23a may include the first elastic member 233_1 and the second elastic member 233_2. One end of the first elastic member 233_1 may be connected to the first spring connection body 232_1 and the other end thereof may be connected to the movement shaft 2243. One end of the second elastic member 233_2 may be connected to the second spring connection body 232_2 and the other end thereof may be connected to the movement shaft 2243.

The first spring connection body 232_1 and the second spring connection body 232_2 may be formed at a predetermined angle from the movement shaft 2243. In this case, the movement shaft 2243 may be stably returned to the reference position even after moving to the lateral sides of the cleaning robot 1 in addition to the rear side of the cleaning robot 1.

When the cover 10 moves by collision with an obstacle or by application of external force, the elastic members 233_1 to 233_2 may be stretched to absorb external force when the movement frame 22 moves. In addition, the elastic members 233_1 to 233_2 may be compressed after being stretched and the cover 10 and the movement frame 22 may be returned to the reference position. In addition, the cover 10 may not move by the elastic members 233_1 to 233_2 when the applied external force is less than a reference level. Therefore, it is possible to solve instability that the cover 10 moves by even small force.

That is, the elastic members 233_1 to 233_2 may elastically support the movement frame 22 and the cover 10 relative to the fixed body 21.

The sensor module 234 may be provided on the holder 231. The sensor module 234 includes a sensor 235 for sensing movement of the movement frame 22. For example, the sensor 235 may be implemented by a Hall sensor. The Hall sensor may mean a sensor for sensing change in magnetic field using the Hall effect.

The movement frame 22 may be connected to a magnetic-material fixing body 2241 for fixing a magnetic material (not shown) for generating a magnetic field. The magnetic material (not shown) fixed to magnetic-material fixing body 2241 may be located at the vertically upper side of the sensor 235 provided in the holder 231. In contrast, when the cover 10 and the movement frame 22 move, the magnetic material (not shown) may escape from the vertical upper side of the sensor 235. As the magnetic material (not shown) moves, the magnetic field may be changed, and the sensor 235 may sense change in magnetic field, thereby sensing movement of the cover 10.

The cleaning robot 1 according to the embodiment of the present invention may include the movement frame 22 movably supporting the cover 10 (in particular, the bottom cover 10c) relative to the fixed body 21. Therefore, even when the cover 10 or the bottom cover 10c moves by collision with an obstacle or by application of external force, the fixed body 21 may not move. That is, since the cover 10 or the bottom cover 10c serves as a bumper, external force is not delivered to the fixed body 21. Therefore, it is possible to prevent the various components included in the fixed body 21 from being damaged or broken.

In addition, the movement frame 22 included in the cleaning robot 1 according to the embodiment of the present invention may have a structure for freely moving the cover 10 upon applying external force while stably supporting the cover 10 having a large volume relative to the fixed body 21. Accordingly, stability of the cleaning robot 1 can be improved and the cover 10 can efficiently serve as a bumper when external force is applied.

The cleaning robot according to the embodiment of the present invention may include a movement frame provided between the cover and the fixed body to movably support the cover relative to the fixed body. Therefore, even when the cover moves by collision with an obstacle or application of external force, the cover and the movement frame may move but the fixed body may not move. That is, even when the cleaning robot collides with an obstacle or receives external force, movement of the fixed body may be minimized and thus the various components included in the fixed body may be prevented from being damaged or broken by collision or external force.

In addition, the cleaning robot according to the embodiment of the present invention may be used at a wide space and have a greater volume and weight than a general cleaning robot. The movement frame included in the cleaning robot may enable the cover to freely move upon applying external force while stably supporting the cover having a large volume relative to the fixed body. Accordingly, stability of the cleaning robot can be improved and the cover may efficiently serve as a bumper upon applying external force, thereby efficiently protecting the components of the robot.

What is claimed is:

1. A cleaning robot comprising:
a fixed body;
a traveling part provided at a lower portion of the fixed body to enable the cleaning robot to move along a floor surface;
a suction part provided at the fixed body to suck foreign materials from the floor surface;
a movement frame supported by the fixed body, the movement frame being movable horizontally with respect to the fixed body; and
a cover surrounding the fixed body, the cover being secured to the movement frame,
wherein the movement frame provided between the cover and the fixed body permits limited movement of the cover with respect to the fixed body.

2. The cleaning robot according to claim 1, wherein the traveling part comprises a plurality of wheels.

3. The cleaning robot according to claim 1, further comprising a side brush protruding from a front lower end of the cover.

4. The cleaning robot according to claim 1, wherein the movement frame includes a plurality of frames, and
wherein the plurality of frames includes:
a first frame located above the fixed body;
a second frame located at a front side of the fixed body;
a third frame located at a first lateral side of the fixed body; and
a fourth frame located at a second lateral side of the fixed body.

5. The cleaning robot according to claim 4, wherein a height of the first frame from the floor surface is different from heights of each of the second, third and fourth frames from the floor surface.

6. The cleaning robot according to claim 4, wherein the plurality of frames further includes:
a fifth frame connecting the first frame to the third frame; and
a sixth frame connecting the first frame to the fourth frame.

7. The cleaning robot according to claim 4, wherein the first, second, third and fourth frames are spaced apart from the cover by a predetermined distance.

8. The cleaning robot according to claim 4, wherein the movement frame further includes at least one fastening frame connected to at least one of the first, second, third and fourth frames, the at least one fastening frame being fastened to the cover at at least one point.

9. The cleaning robot according to claim 1, further comprising:
a plate provided on the fixed body;
an inner body contacting an upper surface of the plate; and
a movement shaft connecting the movement frame to the inner body,
wherein the inner body is horizontally movable with respect to the plate.

10. The cleaning robot according to claim 9, wherein the inner body horizontally moves according to external force applied to the cover.

11. The cleaning robot according to claim 1, further comprising:
a first plate portion provided at a front portion of the fixed body;
a first inner body contacting an upper surface of the first plate portion;
a first movement shaft connecting the movement frame to the first inner body;
a second plate portion provided at a left rear portion of the fixed body;
a second inner body contacting an upper surface of the second plate portion;
a second movement shaft connecting the movement frame to the second inner body;
a third plate portion provided at a right rear portion of the fixed body;
a third inner body contacting an upper surface of the third plate portion; and
a third movement shaft connecting the movement frame to the third inner body,
wherein the first, second and third inner bodies are arranged in a triangular shape.

12. The cleaning robot according to claim 1, further comprising at least one elasticity setting part provided between the movement frame and the fixed body to support the movement frame relative to the fixed body.

13. The cleaning robot according to claim 12, wherein the at least one elasticity setting part includes:
a first elasticity setting part provided at a front side of the fixed body;
a second elasticity setting part provided at a left rear portion of the fixed body; and
a third elasticity setting part provided at a right rear portion of the fixed body,
wherein the first, second and third elasticity setting parts are arranged in a triangular shape.

14. The cleaning robot according to claim 13, wherein the movement frame includes:
a first frame located above the fixed body;
a second frame located at a front side of the fixed body;
a third frame located at a first lateral side of the fixed body; and
a fourth frame located at a second lateral side of the fixed body.

15. The cleaning robot according to claim 14, wherein the first elasticity setting part is connected to the second frame, and
wherein the second elasticity setting part and the third elasticity setting part are connected to the first frame.

16. The cleaning robot according to claim 12, wherein the at least one elasticity setting part includes:
a plate provided on the fixed body;
an inner body contacting an upper surface of the plate; and
a movement shaft connecting the movement frame to the inner body,
wherein the inner body is horizontally movable with respect to the plate.

17. A cleaning robot comprising:
a fixed body;
a traveling part provided at a lower portion of the fixed body to enable the cleaning robot to move along a floor surface;
a suction part provided at the fixed body to suck foreign materials from the floor surface;
a movement frame supported by the fixed body, the movement frame being movable horizontally with respect to the fixed body; and
a cover surrounding the fixed body, the cover being secured to the movement frame,
wherein the movement frame provided between the cover and the fixed body permits limited movement of the cover with respect to the fixed body,
wherein the movement frame includes:
a first frame located above the fixed body;
a second frame located at a front side of the fixed body;
a third frame located at a first lateral side of the fixed body;
a fourth frame located at a second lateral side of the fixed body;
a fifth frame connecting the first frame to the third frame;
a sixth frame connecting the first frame to the fourth frame; and
at least one fastening frame connected to at least one of the first, second, third and fourth frames,
wherein a height of the first frame from the floor surface is different from heights of each of the second, third and fourth frames from the floor surface,
wherein the first, second, third and fourth frames are spaced apart from the cover by a predetermined distance, and
wherein the at least one fastening frame is fastened to the cover at at least one point.

18. The cleaning robot according to claim 17, further comprising an elasticity setting part provided between the movement frame and the fixed body to support the movement frame relative to the fixed body.

19. The cleaning robot according to claim 18, wherein the elasticity setting part includes:
a plate provided on the fixed body;
an inner body contacting an upper surface of the plate; and
a movement shaft connecting the movement frame to the inner body,
wherein the inner body is horizontally movable with respect to the plate.

20. A cleaning robot comprising:
a fixed body;
a traveling part provided at a lower portion of the fixed body to enable the cleaning robot to move along a floor surface;
a suction part provided at the fixed body to suck foreign materials from the floor surface;
a movement frame supported by the fixed body, the movement frame being movable horizontally with respect to the fixed body, the movement frame including:
a first frame located above the fixed body;
a second frame located at a front side of the fixed body;
a third frame located at a first lateral side of the fixed body; and
a fourth frame located at a second lateral side of the fixed body;
a cover surrounding the fixed body, the cover being secured to the movement frame;
a plate provided on the fixed body;
an inner body contacting an upper surface of the plate; and
a movement shaft connecting the movement frame to the inner body,
wherein the inner body, the movement shaft and the movement frame are horizontally movable with respect to the plate to permit limited movement of the cover with respect to the fixed body.
